(19) United States
(12) Patent Application Publication
(10) Pub. No.: US 2012/0149223 A1
(43) Pub. Date: Jun. 14, 2012

(54) ELECTRICAL CONNECTOR HAVING LEVER

(75) Inventors: Steven FELDMAN, Cedar Park, TX (US); Joseph N. CASTIGLIONE, Cedar Park, TX (US); Leon D. SCHMIDT, Cedar Park, TX (US)

(73) Assignee: 3M Innovative Properties Company

(21) Appl. No.: 12/966,097

(22) Filed: Dec. 13, 2010

(51) Int. Cl. H01R 13/62

(52) U.S. Cl. 439/157; 439/160

(57) ABSTRACT

Electrical connector is disclosed. The electrical connector includes a body. The body includes a bottom. The bottom includes a base that is elongated along a first direction between first and second ends of the base. The base includes a plurality of electrical contacts. The body also includes a first side that is proximate the first end of the base. The electrical connector also includes a first lever that is disposed at the first side of the body and is capable of pivoting about a pivot point between first and second end positions. The first lever includes a first portion that is on one side of the pivot point and is configured to latchingly engage a mating connector when the first lever is at the first end position. The first lever also includes a second portion that is on the opposite side of the pivot point and includes a first branch and a second branch. The first branch is configured to at least partially eject an engaged mating connector when the first lever is at the second end position. The second branch is configured to contact the first end of the base when the first lever is at the second end position. When attempting to pivot the first lever beyond the second end position, the base keeps the first lever at the second end position by applying a reaction force to the second branch, where the reaction force is primarily along the first direction.

### FIELD OF THE INVENTION

This invention relates to electrical connectors. In particular, the invention relates to electrical connectors having levers designed not to travel past an intended position.

### BACKGROUND

Electrical connectors are used in many applications for making electrical interconnections. Electrical connectors typically include a plurality of terminals or electrical contacts positioned in a housing. Some electrical connectors include ejector mechanisms to releasably lock and eject mating connectors. Damage to the ejector mechanisms during normal operation is often a problem associated with such electrical connectors. Structural reinforcement of the ejector mechanisms can add to the cost and size of the electrical connectors.

### SUMMARY OF THE INVENTION

Generally, the present invention relates to electrical connectors having one or more levers. In one embodiment, an electrical connector that is configured to receive a mating connector includes a body that includes a bottom that has a base elongated along a first direction between first and second ends of the base, where the base includes a plurality of electrical contacts. The body also includes a first side that is proximate the first end of the base. The electrical connector also includes a first lever that is disposed at the first side of the body and is capable of pivoting about a pivot point between first and second end positions. The first lever includes a first portion on one side of the pivot point that is configured to latchingly engage a mating connector when the first lever is at the first end position. The first lever also includes a second portion that is positioned on the opposite side of the pivot point and includes a first branch that is configured to at least partially eject an engaged mating connector when the first lever is at the second end position. The second portion also includes a second branch that is configured to contact the first end of the base when the first lever is at the second end position. When attempting to pivot the first lever beyond the second end position, the base keeps the first lever at the second end position by applying a reaction force to the second branch that is primarily along the first direction. In some cases, the bottom of the body includes an opening that extends therethrough, where the lever is capable of pivoting about the pivot point within the opening. In some cases, the opening is adjacent to the first end of the base. In some cases, the first side of the body includes an opening that extends therethrough, where the lever is capable of pivoting about the pivot point within the opening. In some cases, the body includes an opening that extends therethrough, where the opening extends from a first location at the bottom of the body to a second location at the side of the body, where the lever is capable of pivoting about the pivot point within the opening. In some cases, the base has a rectangular shape. In some cases, each electrical contact in the plurality of electrical contacts includes a first portion that extends from an interior side of the base and is configured to engage a corresponding electrical contact of a mating connector and a second portion that extends from an opposing exterior side of the base. In some cases, at least the first portions of the electrical contacts in the plurality of electrical contacts extend along a mating direction perpendicular to the first direction. In some cases, when the first lever is in the second end position, at least a portion of the first end of the base is positioned between the first and second branches of the second portion of the first lever. In some cases, when the first lever is in the second end position, a portion of the first branch extends between at least two electrical contacts in the plurality of electrical contacts. In some cases, the first lever is capable of latchingly engaging mating connectors having different heights. In some cases, the first lever is capable of latchingly engaging a mating connector and a strain relief of the mating connector. In some cases, the first lever is designed so that when attempting to pivot the first lever beyond the second end position, the first lever breaks before a different portion of the electrical connector is damaged. In some cases, the first lever has a weakened portion so that when attempting to pivot the first lever beyond the second end position, the first lever breaks at the weakened portion of the first lever before a different portion of the electrical connector is damaged. In some cases, the first lever is reattachably connected to the body of the electrical connector. In some cases, when attempting to pivot the first lever beyond the second end position, the base keeps the first lever at the second end position by applying a reaction force to the second branch, at least 50%, or at least 70%, or at least 90%, of the applied reaction force being along the first direction. In some cases, the body further includes a second side that is proximate the second end of the base. In some cases, the electrical connector also includes a second lever that is disposed at the second side of the body and faces the first lever, where the second lever is capable of pivoting about a pivot point between first and second end positions. The second lever includes a first portion on one side of the pivot point that is configured to latchingly engage a mating connector when the second lever is at the first end position. The second lever also includes a second portion that is located on the opposite side of the pivot point and includes a first branch and a second branch, where the first branch is configured to at least partially eject an engaged mating connector when the second lever is at the second end position, and the second branch is configured to contact the second end of the base when the second lever is at the second end position, such that when attempting to pivot the second lever beyond the second end position, the base keeps the second lever at the second end position by applying a reaction force to the second branch primarily along the first direction. In some cases, when the first lever is at the first end position, the mating connector is fully inserted into the electrical connector. In some cases, the first portion of the first lever is configured to latchingly engage a mating connector and a strain relief of the mating connector when the first lever is at the first end position. In some cases, the first portion of the first lever is configured to latchingly engage two or more mating connectors when the first lever is at the first end position. In some cases, the base contacts the first lever at a first location on the first lever when the first lever is at the first end position and the base contacts the first lever at a different second location on the first lever when the first lever is at the second end position, where the contacts are designed to prevent the first lever from pivoting beyond the first and second end positions. In some cases, the first lever pivoting beyond either of the first and second end positions damages the electrical connector.

In another embodiment, an electrical connector that is configured to receive a mating connector includes a base that includes a mating face and a plurality of electrical contacts; and a lever for ejecting an engaged mating connector when the lever is at an end position, such that when attempting to move the lever beyond the end position, the lever exerts a force on the base that is primarily along the mating face. In some cases, when attempting to move the lever beyond the end position, the lever exerts a force on the base, at least 50%, or at least 60%, or at least 70%, or at least 80%, or at least 90%, of the force being along the mating face.

In another embodiment, an electrical connector that is configured to receive a mating connector includes a base that includes a mating face and a plurality of electrical contacts; and a lever that is configured to pivot about a pivot point between first and second end positions, where the first end position is defined when the base contacts the lever at a first location on the lever, the lever being configured to latchingly engage a mating connector when the lever is at the first end position; and where the second end position is defined when the base contacts the lever at a second location, different than the first location, on the lever, where the lever is configured to at least partially eject an engaged mating connector when the lever is at the second end position, such that when attempting to move the lever beyond the second end position, the lever exerts a force on the base that is primarily along the mating face. In some cases, as a mating connector is inserted into the electrical connector, the lever automatically pivots about the pivot point and latchingly engages the mating connector.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic three-dimensional view of an electrical connector and a mating connector;

FIG. 2 is a different view of the electrical connector and the mating connector in FIG. 1;

FIGS. 3A-3C are schematic side views of an electrical connector and a mating connector for different lever positions; and

FIG. 4 is a schematic side-view of a lever.

In the specification, a same reference numeral used in multiple figures refers to the same or similar elements having the same or similar properties and functionalities.

### DETAILED DESCRIPTION

The present invention generally relates to electrical connectors and, in particular, to electrical connectors that include levers or latches for locking and separating or ejecting mating connectors. The disclosed electrical connectors include levers designed not to travel or pivot past first and second end positions. When the lever is at the first end position, the base of the body of the connector contacts the lever at a first location on the lever and prevents the lever from travelling or pivoting any further, and when the lever is at the second end position, the base contacts the lever at a different second location on the lever and prevents the lever from travelling or pivoting any further. In some cases, the first end position is associated with latchingly engaging a mating connector and the second end position is associated with at least partially ejecting the mating connector. In such cases, when attempting to pivot the lever beyond the second end position, the lever applies to the base a force that is primarily along the length, or the longitudinal axis, of the base. In some cases, the applied force is primarily in a plane that is generally defined by the base, where the plane can, for example, be the mating face of the base. As such, it is highly unlikely that the applied force can damage the connector body. In some cases, when a mating connector is mounted or pressed onto a disclosed electrical connector the levers of the connector automatically lock the mating connector in place. In such cases, as the mating connector is inserted into the electrical connector, the levers automatically pivot about their respective pivot points and latchingly engage the mating connector.

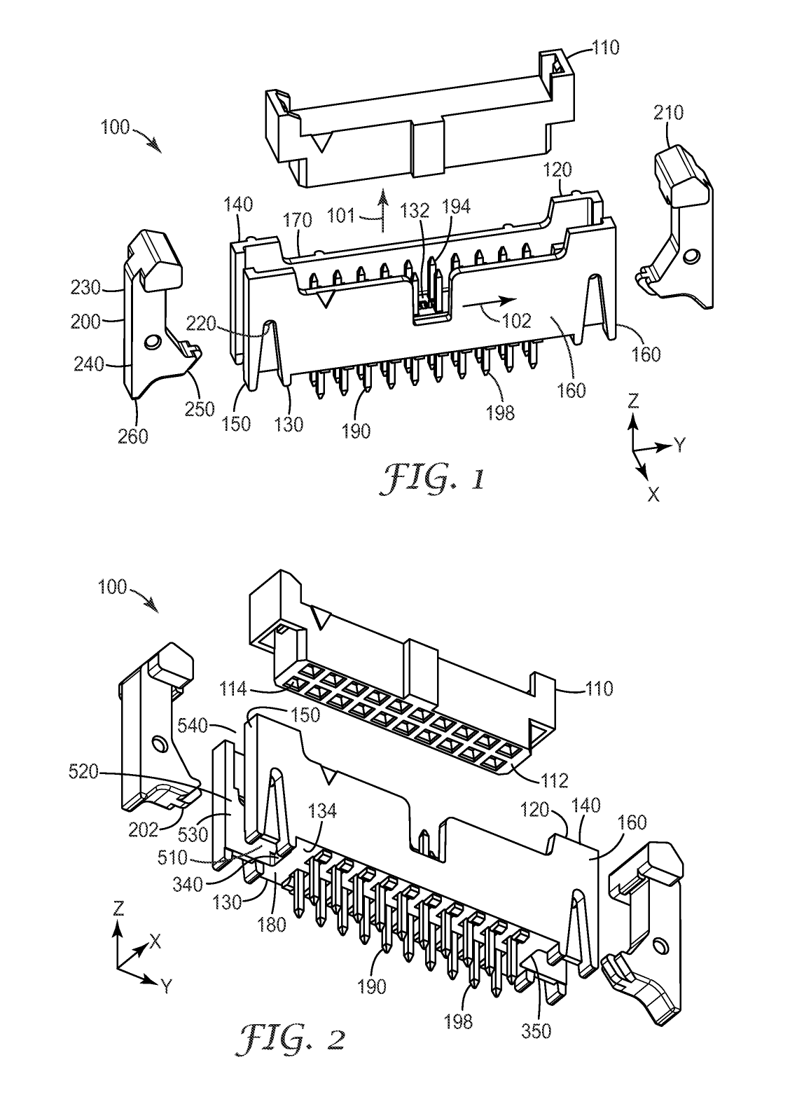

FIGS. 1 and 2 are schematic three-dimensional side and bottom views of an electrical connector 100, respectively, where connector 100 is configured to receive a mating connector 110. Connector 100 includes a body 120, a first lever 200, and an opposing second lever 210 facing first lever 200. Body 120 includes a top 140, a bottom 130 opposite the top, a first side 150, a second side 160 opposite the first side, a front 160, and a back 170 opposite the front. Bottom 130 includes a base 180 that is elongated along a first direction 102 (y-axis or direction) between a first end 340 of the base and a second end 350 of the base. The exemplary connector 100 in FIG. 1 includes an elongated based that lies in the xy-plane with the longitudinal axis of the base being directed along the y-axis. In general, base 180 can have any desired shape and may or may not be elongated in a given direction.

Base 180 includes a plurality of electrical contacts 190 for making electrical connection with corresponding electrical contacts in, for example, a mating connector. Each electrical contact 190 includes a first portion 194 that extends from an interior side 132 of base 180 along the z-axis or direction perpendicular to the base (the xy-plane). In some cases, each first portion 194 is configured to engage a corresponding electrical contact, such as electrical contact 114, of a mating connector, such as mating connector 110. Each electrical contact 190 also includes a second portion 198 that extends from an exterior side 134 of base 180 along the z-direction perpendicular to the base, where exterior side 134 of the base is opposite interior side 132 of the base. In general, each of first portions 194 and second portions 198 of electrical contacts 190 may extend along any desired direction and may or may not be perpendicular to base 180. In some cases, at least first portions 194 of electrical contacts 190 extend along a mating direction 101 (z-direction) that is perpendicular to first direction 102 (y-direction). Second portions 198 can, for example, be configured to engage, or make contact with, a plurality of contacts of a mating connector or a printed circuit board (not shown).

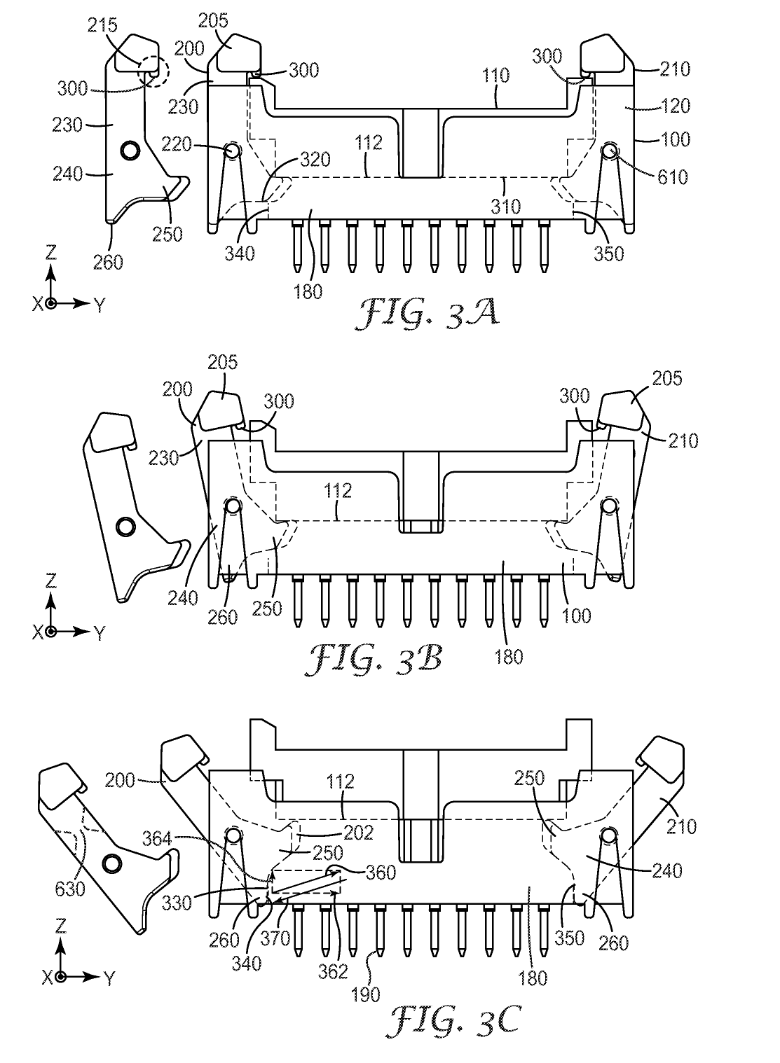

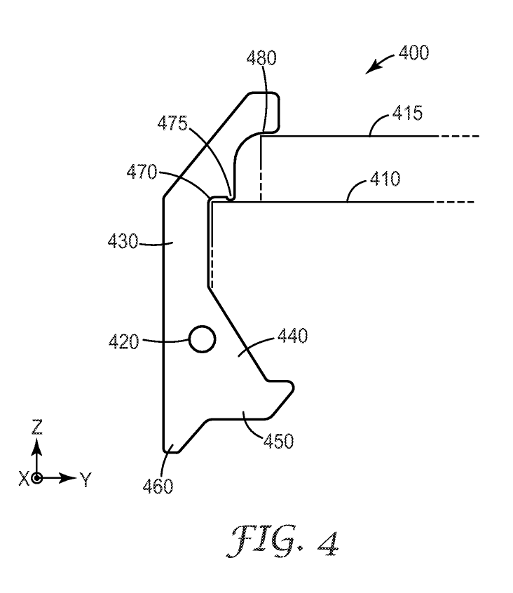

First side 150 of body 120 is positioned proximate first end 340 of base 180 and opposing second side 160 is positioned proximate second end 350 of base 180. First lever 200 is disposed at first side 150 of body 120 and second lever 210 is disposed at second side 160 of body 120 (for ease of viewing levers 200 and 210 are shown separated from body 120) facing the first lever. Each of first and second levers 200 and 210 is capable of pivoting about a pivot point 220 between a first end position schematically illustrated in FIG. 3A and a second end position schematically illustrated in FIG. 3C. Each lever includes a first portion 230 that is on one side of, such as above, pivot point 220 and a second portion 240 that is on an opposite side of, such as below, pivot point 220. Second portion 240 includes a first branch 250 and a second branch 260.

First portion 230 of first lever 200 is configured to latchingly engage mating connector 110 when the first lever is at the first end position as illustrated schematically in FIG. 3A. In particular, first lever 200 includes a head 205 that terminates in a hook 300 that keeps mating connector 110 in a mating position with connector 100 when first lever 200 is at the first end position. In some cases, the first end position is defined when base 180 contacts lever 200 at a first location 320 on the lever, where, in some cases, the contact at the first location is designed to prevent the lever from moving or pivoting beyond the first end position. For example, even in the absence of mating connector 110, by making contact with first lever 200 at first location 320 of the first lever, base 180 prevents the lever from pivoting or turning clockwise past the first end position. In some cases, such as in the exemplary electrical connector 100 schematically shown in FIG. 3A, first location 320 is part of first branch 250.

First branch 250 of first lever 200 is configured to at least partially eject an engaged mating connector, such as engaged mating connector 110, when the first lever is at the second end position as schematically illustrated in FIG. 3C. In particular, when pivoting first lever 200 counter clockwise around its pivot point and pivoting second lever 210 clockwise around its pivot point both starting from their respective first end positions shown in FIG. 3A, the first branches of the two levers work in combination to at least partially eject mating connector 110 as shown schematically in FIG. 3C. In some cases, such as in the case illustrated in FIGS. 1 and 3, first branch 250 of each lever terminates in a narrowed end 202 that makes contact with mating face 112 of the mating connector as the levers eject the mating connector. In some cases, the second end position is defined when base 180 contacts lever 200 at a second location 330 on the lever, where second location 330 is different than first location 320, where second location 330 can be part of second branch 260. When lever 200 is in its second end position, second branch 260 contacts first end 340 of base 180. When attempting to pivot first lever 200 beyond the second end position, second branch 260 applies a force 360 to base 180 that is primarily along the y-direction (first direction) which is along the length of base 180. In general, force 360 can have a first force projection or component 362 along the y-direction and an orthogonal second force projection or component 364 along the z-direction. Force 360 is primary along the y-direction meaning that first force component 362 is at least 50%, or at least 60%, or at least 70%, or at least 80%, or at least 90%, of force 360. When attempting to pivot first lever 200 beyond the second end position, base 180 keeps the first lever at the second end position by applying a reaction force 370 to second branch 260, where reaction force 370 is equal to force 360 but is directed in the opposite direction. Reaction force 370 is primarily along the y- or first direction, meaning that the projection of reaction force 370 along the y-direction, or along the length of base 180, is at least 50%, or at least 60%, or at least 70%, or at least 80%, or at least 90%, of reaction force 370. Hence, when attempting to pivot first lever 200 beyond the second end position, base 180 keeps the first lever at the second end position by applying a reaction force to the second branch, where at least 50%, or at least 60%, or at least 70%, or at least 80%, or at least 90%, of the applied reaction force is along first direction 102, or along mating face 310, or in the plane generally defined by base 180.

In some cases, such as when first lever 200 is in the second end position shown schematically in FIG. 3C, at least a portion of each end of the base is positioned between the first and second branches of the second portion of a corresponding lever. For example, in FIG. 3C, at least a portion of second end 350 of base 180 is positioned between first branch 250 and second branch 260 of second portion 240 of second lever 210.

As illustrated in the exemplary FIG. 3C, narrowed ends 202 of levers 200 and 210 make contact with mating face 112 of mating connector 110 as the levers eject the mating connector. In some cases, when first lever 200 is in the second end position (FIG. 3C), a portion of first branch 250, such as narrowed end 202, extends between at least two electrical contacts 190.

In some cases, connector 100 includes base 180 that includes a mating face 310 that is configured to mate with mating face 112 of mating connector 110. Connector 100 also includes lever 200 for ejecting an engaged mating connector 110 when the lever is at an end position, such as the second end position illustrated in FIG. 3C, such that when attempting to move or pivot lever 200 beyond the end position (counter clockwise in FIG. 3C), the lever exerts force 360 on base 180, where force 360 is primarily along mating face 310 in the xy-plane. Force 360 is primarily along mating face 310 meaning that the projection of force 360 onto mating face 310 (the xy-plane) is at least 50%, or at least 60%, or at least 70%, or at least 80%, or at least 90%, of force 360.

In general, first portion 230 of lever 200 is designed, in part, to latchingly engage mating connector 110 when the lever is at the first end position (FIG. 3A), where the first end position is defined when base 180 contacts the lever at first location 320 on the lever. An advantage of the disclosed embodiments is that as mating connector 110 is inserted into connector 100, levers 200 and 210 automatically pivot in mutually opposing directions to latchingly engage the mating connector. Mating connector 110 is fully inserted into connector 100 when hooks 300 come into contact with the mating connector as illustrated in FIG. 3A. FIG. 3B is a schematic side-view of a connector assembly that includes mating connector 110 partially inserted into electrical connector 100. As illustrated in FIG. 3B, in the case of partial insertion, levers 200 and 210 are positioned somewhere between first and second end positions, base 180 does not contact second portion 240 of lever 200, base 180 does not contact first branch 250 or second branch 260 of second portion 240, levers 200 and 210 do not fully engage the mating connector, and hooks 300 do not contact mating connector 110. In such cases, a viewer can easily recognize that mating connector 110 is not fully inserted into connector 100 because the latches are not fully engaged with the mating connector and the levers are not fully upright. In some cases, when first lever 200 is at the first end position, mating connector 110 is fully inserted into electrical connector 100.

In general, first portion 230 of lever 200 can have any shape that is capable of latchingly engaging one or more mating connectors when the lever is in the first end position (corresponding to, for example, the mating connectors being fully inserted). For example, the exemplary first portion 230 in FIG. 3A is capable of latchingly engaging one mating connector and includes engaging means 215 that, in part, includes hook 300 and an L-shaped profile that for latching purposes, substantially matches the corresponding profile of the mating connector. As another example, FIG. 4 is a schematic side-view of a lever 400 that is capable of pivoting about a pivot point 420 and includes a first portion 430 on one side of, or above, the pivot point and a second portion 440 on the opposite side of, or below, the pivot point, where the second portion includes a first branch 450 and a second branch 460. First portion 430 includes a first engaging means 470 for latchingly engaging a first mating connector 410 when lever 400 is at a first end position (corresponding to, for example, the first mating connector being fully inserted) and a second engaging means 480 for latchingly engaging a second mating connector 415 when lever 400 is at the first end position (corresponding to, for example, the second mating connector being fully inserted into the first mating connector). First engaging means 470 includes a slight hook, protrusion, or lip 475 for engaging the mating connector. In some cases, the second mating connector can be a strain relief or a cover. In general, first portion 430 of lever 400 is configured to latchingly engage two or more mating connectors, such as mating connectors 410 and 415, when lever 400 is at the first end position, where the first end position can, for example, correspond to the mating connectors being fully inserted. In some cases, first portion 430 of lever 400 is configured to latchingly engage mating connector 410 and a strain relief 415 of the mating connector when the lever is at the first end position.

In general, the disclosed electrical connectors are capable of latchingly engaging various mating connectors 110. For example, in some cases, the disclosed connectors are capable of latchingly engaging mating connectors having different heights. For example, lever 400 in FIG. 4, is capable of latchingly engaging mating connectors having at least two different heights. In particular, lever 400 is capable of latchingly engaging a shorter mating connector by using first engaging means 470 and taller mating connector by using second engaging means 480.

In general, second portion 240 of lever 200 is designed, in part, to at least partially eject engaged mating connector 110 when the lever is at the second end position (FIG. 3C), where the second end position is defined when base 180 contacts the lever at second location 330 on the lever, where second location 330 is different than first location 320. A particular advantage of the disclosed electrical connectors is that when attempting to move lever 200 beyond the second end position (counter clockwise for first lever 200), the lever exerts force 360 on the base that is primarily along mating face 310. Since force 360 has a relatively small component along the thickness direction (smaller dimension) of base 180 (z-direction) and a relatively larger component along mating face 310 (larger dimensions), an attempt to pivot the lever beyond its second end position is not likely to damage, such as fracture or break, the base or the body of the connector.

In some cases, levers 200 and 210 are reattachably connected to body 120 of electrical connector 100. For example, in some cases, the levers can be pivotably connected to the sides of body 120 by removably inserted pivot pins 610. In some cases, the levers are designed so that when attempting to pivot, for example, first lever 200 beyond the second end position (FIG. 3C), the first lever breaks before a different portion, such as body 120, of the electrical connector is damaged. For example, in such cases, first lever 200 can have a weakened portion so that when attempting to pivot the first lever beyond the second end position, the first lever breaks at the weakened portion of the first lever before a different portion of the electrical connector is damaged. In general, a weakened portion in the levers can be formed by employing any known method. For example, FIG. 3C shows an example of a weakened portion in the form of a narrowing 630 in the first portion of first lever 200. Another example, of forming a weakened portion includes scoring the levers.

When lever 200 is in the second end position, mating connector 110 is at least partially ejected. In some cases, at the second end position, mating connector 110 is sufficiently ejected so that the mating connector can be readily and fully removed without the need for any instrument to facilitate the removal. In some cases, mating connector 110 is partially ejected even before the lever is in the second end position. For example, as illustrated in FIG. 3B, mating connector 110 is partially ejected by levers 200 and 220 even though the levers are between the first and second end positions.

Referring to FIG. 2, base 180 does not extend the entire bottom 130 of body 120. Rather, bottom 130 of the body includes openings next or adjacent to ends 340 and 350 of the base to allow the levers to travel or rotate therein. In particular, bottom 130 includes an opening 510 that is adjacent to first end 350 of base 180 and extends through the thickness of the base and forms a through opening in body 120. First lever 200 is capable of pivoting about pivot point 220 within opening 510.

Each of sides 150 and 160 of body 120 includes an opening that extends through the side, forms a through opening in the body, and allows the corresponding lever to travel or rotate within the opening. In particular, first side 150 of body 120 includes an opening 520 that extends through the first side and forms a through opening in body 120. First lever 200 is capable of pivoting about pivot point 220 within opening 520.

In some cases, openings 510 and 520 meet or merge and form a single opening, such as opening 530, on the side of the connector. For example, body 120 in FIG. 2 includes an opening 530 that extends through the body. Opening 530 extends from a first location (for example, first end 340 of base 180) at bottom 130 of the body to a second location 540 at first side 150 of the body. First lever 200 is capable of pivoting about pivot point 220 within opening 530.

The exemplary base 180 is FIG. 2 has a rectangular shape. In general, base 180 and connector 100 can have any shape that may be desirable in an application. For example, in some cases, base 180 can have a square shape.

The exemplary disclosed electrical connectors include two levers facing each other, each being disposed on a side of the connector. In general, the disclosed electrical connectors can have one or more levers for latchingly engaging a mating connector and for at least partially ejecting an engaged mating connector. The body of the disclosed electrical connectors and the levers can be made of any suitable material such as plastic and metal. The electrical contacts can be made of any suitable electrically conductive material such as copper.

As used herein, terms such as “vertical”, “horizontal”, “above”, “below”, “top”, “bottom' “left”, “right”, “upper” and “lower”, “clockwise” and “counter clockwise” and other similar terms, refer to relative positions as shown in the figures. In general, a physical embodiment can have a different orientation, and in that case, the terms are intended to refer to relative positions modified to the actual orientation of the device. For example, even if the image in FIG. 1 is flipped as compared to the orientation in the figure, first portion 230 is still considered to be above pivot point 220.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. An electrical connector configured to receive a mating connector and comprising:
a body comprising:
a bottom comprising a base elongated along a first direction between first and second ends of the base, the base comprising a plurality of electrical contacts; and
a first side proximate the first end of the base; and
a first lever disposed at the first side of the body and capable of pivoting about a pivot point between first and second end positions, the first lever comprising:
a first portion on one side of the pivot point configured to latchingly engage a mating connector when the first lever is at the first end position; and
a second portion on the opposite side of the pivot point and comprising:
a first branch configured to at least partially eject an engaged mating connector when the first lever is at the second end position; and
a second branch configured to contact the first end of the base when the first lever is at the second end position, such that when attempting to pivot the first lever beyond the second end position, the base keeps the first lever at the second end position by applying a reaction force to the second branch primarily along the first direction.

2. The electrical connector of claim 1, wherein the bottom of the body comprises an opening extending therethrough, the lever being capable of pivoting about the pivot point within the opening.

3. The electrical connector of claim 2, wherein the opening is adjacent to the first end of the base.

4. The electrical connector of claim 1, wherein the first side of the body comprises an opening extending therethrough, the lever being capable of pivoting about the pivot point within the opening.

5. The electrical connector of claim 1, wherein the body comprises an opening extending therethrough, the opening extending from a first location at the bottom of the body to a second location at the side of the body, the lever being capable of pivoting about the pivot point within the opening.

6. The electrical connector of claim 1, wherein the base has a rectangular shape.

7. The electrical connector of claim 1, wherein each electrical contact in the plurality of electrical contacts comprises a first portion extending from an interior side of the base and configured to engage a corresponding electrical contact of a mating connector and a second portion extending from an opposing exterior side of the base.

8. The electrical connector of claim 7, wherein at least the first portions of the electrical contacts in the plurality of electrical contacts extend along a mating direction perpendicular to the first direction.

9. The electrical connector of claim 1, wherein when the first lever is in the second end position, at least a portion of the first end of the base is positioned between the first and second branches of the second portion of the first lever.

10. The electrical connector of claim 1, wherein when the first lever is in the second end position, a portion of the first branch extends between at least two electrical contacts in the plurality of electrical contacts.

11. The electrical connector of claim 1, wherein the first lever is capable of latchingly engaging mating connectors having different heights.

12. The electrical connector of claim 1, wherein the first lever is capable of latchingly engaging a mating connector and a strain relief of the mating connector.

13. The electrical connector of claim 1, wherein the first lever is designed so that when attempting to pivot the first lever beyond the second end position, the first lever breaks before a different portion of the electrical connector is damaged.

14. The electrical connector of claim 13, wherein the first lever has a weakened portion so that when attempting to pivot the first lever beyond the second end position, the first lever breaks at the weakened portion of the first lever before a different portion of the electrical connector is damaged.

15. The electrical connector of claim 1, wherein the first lever is reattachably connected to the body of the electrical connector.

16. The electrical connector of claim 1, wherein when attempting to pivot the first lever beyond the second end position, the base keeps the first lever at the second end position by applying a reaction force to the second branch, at least 50% of the applied reaction force being along the first direction.

17. The electrical connector of claim 1, wherein when attempting to pivot the first lever beyond the second end position, the base keeps the first lever at the second end position by applying a reaction force to the second branch, at least 70% of the applied reaction force being along the first direction.

18. The electrical connector of claim 1, wherein when attempting to pivot the first lever beyond the second end position, the base keeps the first lever at the second end position by applying a reaction force to the second branch, at least 90% of the applied reaction force being along the first direction.

19. The electrical connector of claim 1, wherein the body further comprises a second side proximate the second end of the base.

20. The electrical connector of claim 19 further comprising a second lever disposed at the second side of the body and facing the first lever, the second lever being capable of pivoting about a pivot point between first and second end positions, the second lever comprising:
a first portion on one side of the pivot point configured to latchingly engage a mating connector when the second lever is at the first end position; and
a second portion on the opposite side of the pivot point and comprising:
a first branch configured to at least partially eject an engaged mating connector when the second lever is at the second end position; and
a second branch configured to contact the second end of the base when the second lever is at the second end position, such that when attempting to pivot the second lever beyond the second end position, the base keeps the second lever at the second end position by applying a reaction force to the second branch primarily along the first direction.

21. The electrical connector of claim 1, wherein when the first lever is at the first end position, the mating connector is fully inserted into the electrical connector.

22. The electrical connector of claim 1, wherein the first portion of the first lever is configured to latchingly engage a mating connector and a strain relief of the mating connector when the first lever is at the first end position.

23. The electrical connector of claim 1, wherein the first portion of the first lever is configured to latchingly engage two or more mating connectors when the first lever is at the first end position.

24. The electrical connector of claim 1, wherein the base contacts the first lever at a first location on the first lever when the first lever is at the first end position and the base contacts the first lever at a different second location on the first lever when the first lever is at the second end position, the contacts being designed to prevent the first lever from pivoting beyond the first and second end positions.

25. The electrical connector of claim 1, wherein the first lever pivoting beyond either of the first and second end positions damages the electrical connector.

26. An electrical connector configured to receive a mating connector and comprising:
a base comprising a mating face and a plurality of electrical contacts; and
a lever for ejecting an engaged mating connector when the lever is at an end position, such that when attempting to move the lever beyond the end position, the lever exerts a force on the base that is primarily along the mating face.

27. The electrical connector of claim 26, wherein when attempting to move the lever beyond the end position, the lever exerts a force on the base, at least 50% of the force being along the mating face.

28. An electrical connector configured to receive a mating connector and comprising:
a base comprising a mating face and a plurality of electrical contacts; and
a lever configured to pivot about a pivot point between:
a first end position defined when the base contacts the lever at a first location on the lever, the lever being configured to latchingly engage a mating connector when the lever is at the first end position; and
a second end position defined when the base contacts the lever at a second location, different than the first location, on the lever, the lever being configured to at least partially eject an engaged mating connector when the lever is at the second end position, such that when attempting to move the lever beyond the second end position, the lever exerts a force on the base that is primarily along the mating face.

29. The electrical connector of claim 28, wherein as a mating connector is inserted into the electrical connector, the lever automatically pivots about the pivot point and latchingly engages the mating connector.
